(19) United States
(12) Patent Application Publication
(10) Pub. No.: US 2026/0237231 A1
(43) Pub. Date: Aug. 13, 2026

(54) SYSTEM AND METHOD FOR EFFICIENTLY PERFORMING KD-BASED GT LABELING TO OPTIMIZE OBJECT COMPUTATION REQUIRED FOR AUTONOMOUS DRIVING

(71) Applicants: HYUNDAI MOTOR COMPANY, Seoul (KR); Kia Corporation, Seoul (KR)

(72) Inventor: Su Rin JO, Gyeonggi-do (KR)

(21) Appl. No.: 19/377,188

(22) Filed: Nov. 3, 2025

(30) Foreign Application Priority Data
Feb. 7, 2025 (KR) 10-2025-0015956

(51) Int. Cl. G06V 20/70; G01S 17/89; G06T 15/08; G06V 10/25; G06V 10/764; G06V 20/58

(52) U.S. Cl. CPC G06V 20/70; G01S 17/89; G06T 15/08; G06V 10/25; G06V 10/764; G06V 20/58; G06V 2201/07

(57) ABSTRACT

A method includes obtaining point cloud data including a plurality of points, assigning GT label data for a plurality of GT bounding boxes to the point cloud data, obtaining P-Box label data for a plurality of predicted bounding boxes based on the point cloud data from a pre-trained machine-learning network, selecting an object that overlaps the P-Box label data from the GT label data and determining an occupancy ratio for the object in a geometric region corresponding to the object, and based on the occupancy ratio not satisfying a first criteria, filtering out the GT label data assigned to the object that does not satisfy the first criteria to update the GT label data.

### CROSS-REFERENCE TO RELATED APPLICATION

Pursuant to 35 U.S.C. § 119(a), this application claims the benefit of an earlier filing date and right of priority to Korean Patent Application No. 10-2025-0015956, filed in the Korean Intellectual Property Office on Feb. 7, 2025, the entire contents of which are incorporated herein by reference.

### TECHNICAL FIELD

The present disclosure generally relates to object detection in autonomous driving systems.

### BACKGROUND

With the recent development and commercialization of autonomous vehicles, the use of various sensors and artificial intelligence (AI) technologies to support the autonomous driving function of vehicles is increasing. For example, research is being conducted on what object is present in front of a driving vehicle, how far an object is from the vehicle, and what algorithm the vehicle should use to respond to specific situations to ensure safety.

Accordingly, vehicle sensor technology is becoming more advanced, and high-performance sensors such as LiDAR (Light Detection and Ranging), which uses laser beams to recognize surrounding environment, RADAR (Radio Detection and Ranging) using radio waves, ultrasonic sensors, Fisheye cameras capable of 360-degree image capture, multi-focal lenses, and GPS (Global Positioning System) are being installed in vehicles.

Also, it has become possible to implement a so-called super sensor vehicle by aggregating measurement results obtained from multiple sensors. In self-driving or autonomous driving, the concept of a super sensor refers to a technology to more accurately recognize the surrounding environment by combining measurements from various sensors rather than relying on individual sensors for driving convenience or safety. With the addition of Information and Communications Technology (ICT) and cloud technology, sensors and related AI algorithms required for autonomous driving are becoming unprecedentedly sophisticated by remotely accumulating data in fleet of vehicles rather than a single vehicle, and training AI servers and databases to increase the reliability of measurements of vehicle sensors.

### SUMMARY

A first aspect of the present disclosure relates to a system for labeling GT (Ground Truth) bounding boxes in AI object recognition for autonomous driving. The system according to the first aspect of the present disclosure can include at least one processor and at least one memory, e.g., in a cloud server equipped with an AI object recognition algorithm as an object recognition module and a database, a network interface configured to receive point cloud data including a plurality of points, from a two-dimensional or three-dimensional image sensor used in the autonomous driving. The object recognition module may obtain the point cloud data including the plurality of points, from the two-dimensional or three-dimensional image sensor used in the autonomous driving, assign GT label data for a plurality of GT bounding boxes to the point cloud data, obtain P-Box label data for a plurality of predicted bounding boxes based on the point cloud data from a pre-trained machine-learning (e.g., teacher) network, select an object that overlaps the P-Box label data from the GT label data and determine an occupancy ratio for the selected object in a geometric region corresponding to the object,, and when the occupancy ratio does not satisfy a first criteria, filter out the GT label data assigned to the object that does not meet the first criteria to update the GT label data.

A second aspect of the present disclosure relates to a method for labeling GT (Ground Truth) bounding boxes in AI object recognition for autonomous driving. The second aspect of the present disclosure provides a method for efficiently performing KD-based GT labeling knowledge distillation including obtaining a point cloud data including a plurality of points, from a two-dimensional or three-dimensional image sensor used in the autonomous driving, assigning GT label data for a plurality of GT bounding boxes to the point cloud data, obtaining P-Box label data for a plurality of predicted bounding boxes based on the point cloud data from a pre-trained machine-learning (e.g., teacher) network, selecting an object that overlaps the P-Box label data from the GT label data and determining an occupancy ratio for the selected object in a geometric region corresponding to the object, and when the occupancy ratio does not satisfy a first criteria, filtering out the GT label data assigned to the object that does not satisfy the first criteria to update the GT label data.

In the method for efficiently performing KD-based GT labeling according to a third aspect of the present disclosure, among the plurality of predicted bounding boxes identified by the pre-trained machine learning network, a predicted bounding box whose prediction score satisfied a second criteria may be included in the P-Box label data.

In the method for efficiently performing KD-based GT labeling according to a fourth aspect of the present disclosure, the image sensor may be a LiDAR, and the occupancy ratio may be a voxel occupancy ratio.

In the method for efficiently performing KD-based GT labeling according to a fifth aspect of the present disclosure, in addition to the first criteria, an additional filtering criterion is used for filtering the GT label data, where the additional filtering criterion depends on at least one driving situation.

In the method for efficiently performing KD-based GT labeling according to a sixth aspect of the present disclosure, the additional filtering criterion based on at least one driving situation may include an AI determination on a class to which an object to be filtered belongs.

In the method for efficiently performing KD-based GT labeling according to a seventh aspect of the present disclosure, the additional filtering criterion may include an AI determination regarding whether an object to be filtered is located outside of a road boundary.

In the method for efficiently performing KD-based GT labeling according to an eighth aspect of the present disclosure, the additional filtering criterion may include an AI determination regarding whether an object to be filtered is located in an area where a vehicle currently in use is unable to physically drive.

In the method for efficiently performing KD-based GT labeling according to a ninth aspect of the present disclosure, the additional filtering criterion may include an AI determination regarding whether an object to be filtered is in a same direction as a driving direction of a vehicle currently in use, and to further utilize positioning information or segmentation information for determination of the driving direction.

In the method for efficiently performing KD-based GT labeling according to a tenth aspect of the present disclosure, determining the occupancy ratio includes determining the geometric region as a space of size (a×b×c) voxels including a predetermined number of voxels for the selected object, identifying a voxel occupied by at least one of the plurality of points as an occupied voxel, and determining the occupancy ratio by determining a number of occupied voxels compared to a total number (a×b×c) of voxels.

In the method for efficiently performing KD-based GT labeling according to an eleventh aspect of the present disclosure, the first criteria may be variable depending on a type of the LiDAR or a mounting position of the LiDAR.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating an example of an overall system for automatically recognizing an object and controlling a vehicle for purposes of autonomous driving, according to an implementation of the present disclosure;

FIG. 2 is an illustrative diagram showing an example of a Bird's Eye View (BEV) of a LiDAR point cloud to which KD-based GT filtering technology according to an implementation of the present disclosure is able to be applied;

FIG. 3 is a diagram showing an example intersection to illustrate KD-based GT filtering technique according to an implementation of the present disclosure;

FIG. 4 is an illustrative diagram to describe an example of a method of calculating a voxel occupancy ratio according to an implementation of the present disclosure;

FIGS. 5A and 5B are diagrams illustrating an example of a first case to which the KD-based GT filtering technique according to an implementation of the present disclosure is applied;

FIG. 6 is a diagram for describing an example of a second case to which the KD-based GT filtering technique according to an implementation of the present disclosure is applied;

FIGS. 7A and 7B are diagrams for describing an example of a third case to which the KD-based GT filtering technique according to an implementation of the present disclosure is applied;

FIG. 8 is a flowchart generally illustrating an example of the KD-based GT filtering algorithm according to an implementation of the present disclosure; and

FIG. 9 is a block diagram illustrating an example of a computing system for autonomous vehicle control and object computation efficiency according to an implementation of the present disclosure.

### DETAILED DESCRIPTION

The advancement of vehicle sensors has resulted in increased amounts of computation for AI systems to process for autonomous driving. Voxel technology applied to 3D (three-dimensional) images allows for more precise 3D environment representation compared to traditional polygon techniques used to represent 3D objects. However, as the resolution increases, not only does the memory load increase, but the computational burden on the CPU (Central Processing Unit) and GPU (Graphic Processing Unit) may grow exponentially.

Accurately recognizing the driving situation of a vehicle and objects around the vehicle using sensors such as LiDAR is an essential technology for autonomous driving, but processing all high-resolution LiDAR data in real time poses the risk that the amount of computation that a CPU or a GPU for autonomous driving needs to process becomes unrealistic.

Accordingly, there is a need for improving the efficiency of object-related computation in autonomous driving.

Implementations of the present disclosure provide a system and a method that can efficiently perform Knowledge Distillation (KD)-based Ground Truth (GT) labeling to improve object computation for autonomous driving. In some implementations, GT labeling can be efficiently performed by filtering out objects that may not need to be considered by a self-driving vehicle implementing a Teacher Network to enhance computational efficiency for autonomous driving.

The technical problems to be solved by the present disclosure are not limited to the aforementioned problems, and any other technical problems not mentioned herein will be clearly understood from the following description by those skilled in the art to which the present disclosure pertains.

To address all or at least some of the aforementioned technical problems, the present disclosure may be implemented in various aspects as follows.

According to implementations of the present disclosure, Knowledge Distillation (KD) can utilize a teacher-student network structure. For example, a teacher network can be pre-trained to perform high-performance object computation and P-Box generation, and filter and remove GT labeling for objects that do not meet a parameter condition of a pixel occupancy ratio among objects of which GT bounding box and P-Box are matched.

In autonomous driving scenarios, a road environment can include object information that is essential for driving, but in some cases, can also include a large number of object information that is not essential for driving of the vehicle. Implementations of the present disclosure can implement a teacher network to perform GT labeling. This can have a technical benefit of a dramatic but reasonable reduction in the number of objects subject to AI computation.

In a three-dimensional driving environment, the concept of voxels can be utilized. A voxel is a 3-D unit of space, analogous to a pixel in a 2D image. Multiple voxels can form a voxel cube. For example, 512 voxels in the form of an 8×8×8 voxel cube may correspond to a 3D object. When at least one point of a point cloud is included in a voxel, the voxel is considered to be occupied. For a voxel cube, the voxel occupancy ratio can be determined for the corresponding object by determining the ratio of voxels that are occupied in the cube.

When the voxel occupancy ratio exceeds a threshold, then the object corresponding to the voxel cube may be included for GT labeling (thus, not excluded by GT filtering). For example, when 76 to 77 voxels of 512 voxels are occupied, a corresponding object may be determined as an object exceeding a first threshold of 15%, and the object may be not excluded from GT labeling. This can help prevent the occurrence of scenarios where an object that is important in the context of the current autonomous driving situation from being excluded from object computation.

Furthermore, implementations of the present disclosure can determine whether a GT bounding box overlaps a P-Box only when the prediction score of the P-Box generated by the teacher network is above a certain level, to select an object target for which a pixel or voxel occupancy ratio is calculated as described above. This can have the technical effect of reducing the amount of AI computation related to object recognition.

Furthermore, implementations of the present disclosure can additionally utilize road situation information, in addition to the pixel occupancy ratio, to filter GT labeling. For example, a vehicle parked beyond a road boundary may be treated as an object that does not need to be considered when computing the driving algorithm of a currently driving vehicle. As another example, other vehicles driving on overpasses that a currently driving vehicle is unable to enter, or vehicles approaching from the opposite lane of the currently driving vehicle, may be filtered out of the GT labeling. This can have technical benefits of simplifying the updated GT bounding box, which can be used for object recognition to streamline AI computation without compromising driving stability.

These and other effects will be understood by those skilled in the art from the detailed description of the present disclosure and the accompanying drawings.

Hereinafter, some implementations of the present disclosure will be described in detail with reference to the exemplary drawings. In adding the reference numerals to the components of each drawing, it should be noted that the identical or equivalent component is designated by the identical numeral even when they are displayed on other drawings. Further, in describing the implementation of the present disclosure, a detailed description of well-known features or functions will be ruled out in order not to unnecessarily obscure the gist of the present disclosure.

In describing the components of implementations according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application. For example, in the present disclosure, the term “object” has essentially the same meaning as “entity,” and the expressions “object” and “entity” will be used interchangeably throughout the present disclosure.

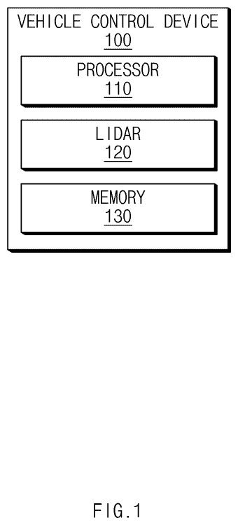

FIG. 1 is a block diagram illustrating an example of an overall system for automatically recognizing an object and controlling a vehicle for purposes of autonomous driving, according to an implementation of the present disclosure.

Referring to FIG. 1, a vehicle control device 100 according to an implementation of the present disclosure may be implemented inside or outside a vehicle, and part of components included in the vehicle control device 100 may be implemented inside or outside the vehicle. In some implementations, the vehicle control device 100 may be integrally formed with internal control units of the vehicle, or may be implemented as a separate device and connected to the control units of the vehicle by separate connection technique. For example, the vehicle control device 100 may further include components not shown in FIG. 1.

The vehicle control device 100 according to an implementation may include a processor 110, a sensor 120 (e.g., LiDAR or other sensor), and a memory 130. The processor 110, the sensor 120, or the memory 130 may be electronically and/or operably coupled with each other by an electronical component including a communication bus.

Hereinafter, hardware being operatively combined may include that a direct connection or an indirect connection between the hardware is established in a wired and/or wireless manner, such that second hardware is controlled by first hardware among the hardware.

Although illustrated in different blocks in FIG. 1, the implementations are not limited thereto. For example, a part of the pieces of hardware of FIG. 1 may be included in a single integrated circuit, including a system on a chip (SoC). The types and/or number of pieces of hardware included within the vehicle control device 100 are not limited to those shown in FIG. 1. For example, the vehicle control device 100 may include only a part of the hardware shown in FIG. 1.

The vehicle control device 100 according to an implementation may include hardware for processing data based on one or more instructions. For example, the hardware for processing the data may include the processor 110. For example, the hardware for processing data may include an arithmetic and logic unit (ALU), a floating point unit (FPU), a field programmable gate array (FPGA), a central processing unit (CPU), and/or an application processor (AP). The processor 110 may have the structure of a single-core processor, or the structure of a multi-core processor including dual core, quad core, Hexa-core, or octa core.

According to an implementation, the processor 110 may include at least one of a graphic processing unit (GPU), or a neural processing unit (NPU), or any combination thereof. For example, the GPU may be referred to as a visual processing unit (VPU). For example, the NPU may be referred to as a neural network processing unit.

According to an implementation, the vehicle control device 100 may include a sensor 120, such as a depth sensor for detecting an external object. For example, the sensor 120 for detecting an external object may include at least one of a time of flight (ToF) sensor, light detection and ranging (LiDAR), a structured light sensor, an ultrasonic sensor, an infrared sensor, a radio detection and ranging (RADAR) sensor, or an optical distance sensor, or any combination thereof. For ease of description, the following discussion will focus on the LiDAR, but implementations are not limited thereto, and the sensor 120 may be implemented as other types of sensors.

According to an implementation, the vehicle control device 100 may include the LiDAR sensor 120 (or simply referred to as LiDAR 120) that acquires a plurality of points based on a pulsed laser signal. For example, the LiDAR 120 can acquire sets of data identifying a surrounding object of the vehicle control device 100 (or a vehicle including the vehicle control device 100). For example, the LiDAR 120 may identify at least one of a position, a movement direction, or a speed of the surrounding object, or any combination thereof based on the pulse laser signal emitted from the LiDAR 120 being reflected off the surrounding object and returning.

For example, the LiDAR 120 may acquire data sets representing an external object in a space formed by the x-axis, the y-axis, and the z-axis based on the pulse laser signal reflected from the surrounding object. For example, the LiDAR 120 may acquire data sets that include a plurality of points in the space formed by the x-axis, the y-axis, and the z-axis based on receiving a pulse laser signal at specified intervals. For example, the plurality of points may include points representing an external object within a three-dimensional virtual coordinate system. The three-dimensional virtual coordinate system may include at least one of a vehicle coordinate system or a LiDAR coordinate system, or any combination thereof. However, examples of three-dimensional virtual coordinate systems are not limited to the above-described coordinate systems.

According to an implementation, the memory 130 of the vehicle control device 100 may include hardware components for storing data and/or instructions that are input to and/or output from the processor 110 of the vehicle control device 100. For example, the memory 130 may include a volatile memory including a random-access memory (RAM), or a non-volatile memory including a read-only memory (ROM).

For example, the volatile memory may include at least one of dynamic RAM (DRAM), static RAM (SRAM), cache RAM or pseudo SRAM (PSRAM), or any combination thereof. For example, the non-volatile memory may include at least one of programmable ROM (PROM), erasable PROM (EPROM), electrically erasable PROM (EEPROM), flash memory, hard disk, compact disc, solid state drive (SSD) or embedded multi-media card (eMMC), or any combination thereof.

For example, the memory 130 of the vehicle control device 100 may store one or more instructions (or commands) indicating arithmetic operations and/or operations to be performed on data by the processor 110 of the vehicle control device 100. A set of one or more instructions may be referred to as a program, firmware, operating system, process, routine, sub-routine, and/or application.

In the following, an application being installed in the vehicle control device 100 may mean that one or more instructions provided in the form of an application are stored in the memory 130, wherein the one or more applications are stored in an executable format (e.g., a file with an extension specified by the operating system of the vehicle control device 100) by the processor 110 of the vehicle control device 100.

For example, the memory 130 may include a first neural network model for detecting an object. For example, the memory 130 may include a second neural network model for outputting types of the plurality of points acquired by the LiDAR 120, and/or a score of the plurality of points.

In an implementation, the processor 110 may obtain at least one of a first virtual box for representing a target object, or a first class for representing a type of the target object, or any combination thereof, based on the plurality of points obtained by the LiDAR 120 and the first neural network model stored in the memory 130.

For example, based on inputting the plurality of points into the first neural network model, the processor 110 may obtain at least one of the first virtual box for representing the target object or the first class representing the type of the target object, or any combination thereof. For example, the first neural network model may include an object detection model. For example, the target object may include an external object located within a specified distance from the vehicle control device 100 (or a host vehicle including the vehicle control device 100). For example, the target object may include an object that is identified by the vehicle control device 100 and is tracked, e.g., continuously tracked. For example, the type of the target object may include one or more of a plurality of types for categorizing the target object. For example, the type of the target object may include at least one of a first type representing the ground or a second type representing a type different from the ground, or any combination thereof. However, the type of the target object is not limited to the above-described types. For example, the type of the target object may include, but is not limited to, at least one of a third type representing a person or a fourth type representing a vehicle, or any combination thereof.

In an implementation, the processor 110 may obtain, based on the plurality of points and a second neural network model, at least one of first sub-points corresponding to at least a part of the target object among the plurality of points or a second class identified through the first sub-points and representing the type of the target object, or any combination thereof. For example, the second neural network model may comprise a segmentation model.

For example, the second neural network model may include a neural network model for obtaining the types of the plurality of points and scores of the plurality of points.

For example, the processor 110 may obtain the first sub-points corresponding to at least a part of the target object among the plurality of points, based on inputting the plurality of points into the second neural network model. For example, the processor 110 may identify the type of the plurality of points based on inputting the plurality of points into the second neural network model. For example, based on the type of each of the plurality of points, the processor 110 may obtain first sub-points that correspond to at least a part of the target object among the plurality of points based on the type of the plurality of points.

In an implementation, the processor 110 may perform a first specified algorithm on the plurality of points. For example, the processor 110 may perform the first specified algorithm on the plurality of points to classify a type of each of the plurality of points. For example, the processor 110 may classify second sub-points corresponding to a specified type among the plurality of points. For example, the specified type may include a type that represents the ground.

For example, the processor 110 may classify the second sub-points corresponding to the specified type based on performing the first specified algorithm on the plurality of points, and obtain (or identify) the first sub-points by excluding the second sub-points among the plurality of points.

In an implementation, the processor 110 may obtain at least one of a subclass to obtain a second class, or a score for each of the plurality of points, or any combination thereof, based on inputting the plurality of points into the second neural network model. For example, the processor 110 may obtain the subclass and the score for each of the plurality of points, based on inputting the plurality of points into the second neural network model. For example, the subclass may include categorizing each of the plurality of points into a certain type.

For example, the processor 110 may fuse the subclass, the score of each of the plurality of points, and the second sub-points. For example, the processor 110 may perform clustering based on a fusion of the subclass, the score of each of the plurality of points, and the second sub-points. For example, the clustering may include grouping the first sub-points corresponding to at least a part of the target object.

For example, the processor 110 may obtain a point cloud for generating a second virtual box based on the first sub-points. For example, the processor 110 may obtain a point cloud based on grouping the first sub-points.

For example, the processor 110 may, based on the point cloud, generate a second virtual box for representing the target object that is different from the first virtual box. For example, the second virtual box may include a box that includes at least a part of the first sub-points.

For example, the processor 110 may identify, based on at least one of the first sub-points or the point cloud, or any combination thereof, a heading direction indicative of a direction of movement of the target object.

For example, the processor 110 may identify, based on at least one of the first sub-points or the point cloud, or any combination thereof, a position of the second virtual box in a virtual coordinate system. For example, the processor 110 may identify a size of the second virtual box based on at least one of the first sub-points or the point cloud, or any combination thereof. For example, the processor 110 may identify a second class, based on at least one of the first sub-points or the point cloud, or any combination thereof. For example, the processor 110 may identify at least one of a heading direction indicating the direction of movement of the target object, the position of the second virtual box in the virtual coordinate system, the size of the second virtual box, or the second class, or any combination of these, based on at least one of the first sub-points or the point cloud, or any combination thereof. For example, the processor 110 may identify the heading direction of a bounding box based on at least one of the first virtual box, the first class, the heading direction of the second virtual box, the position of the second virtual box, the size of the second virtual box, or the second class, or any combination thereof. For example, the processor 110 may identify the position of a bounding box in the virtual coordinate system based on at least one of the first virtual box, the first class, the heading direction of the second virtual box, the position of the second virtual box, the size of the second virtual box, or the second class, or any combination thereof. For example, the processor 110 may obtain a third class representing a type of the target object corresponding to a bounding box, based on at least one of the first virtual box, the first class, the heading direction of the second virtual box, the position of the second virtual box, the size of the second virtual box, or the second class, or any combination thereof. For example, the processor 110 may obtain at least one of the heading direction of the bounding box, the position of the bounding box in the virtual coordinate system, or the third class representing the type of the target object corresponding to the bounding box, or any combination thereof, based on at least one of the first virtual box, the first class, the heading direction of the second virtual box, the position of the second virtual box, the size of the second virtual box, or the second class, or any combination thereof.

For example, the processor 110 may assign, to the second virtual box, a first identifier for tracking the second virtual box. For example, the processor 110 may assign, to the bounding box, a second identifier corresponding to the first identifier.

For example, the processor 110 may track the bounding box using the second identifier. For example, the processor 110 may track the target object based on identifying a plurality of bounding boxes including the bounding box assigned with the second identifier, from a plurality of frames. For example, in scenarios where the second identifier is assigned to a bounding box corresponding to the target object, the processor 110 can track the target object by identifying the plurality of bounding boxes assigned with the second identifier from the plurality of frames.

In an implementation, the processor 110 can output a bounding box corresponding to the target object based on at least one of the first virtual box, the first class, the first sub-points, or the second class, or any combination thereof. For example, the bounding box may include an example where the target object is represented as a cuboid in a virtual coordinate system.

Below is a brief description of the operations performed by a CPU, GPU, and/or NPU included in the processor 110.

In an implementation, the processor 110 may include at least one of a CPU, a GPU, or an NPU, or any combination thereof. For example, at least one of the GPU or the NPU, or any combination thereof may obtain a first virtual box and a first class based on a first neural network model. For example, at least one of the GPU or the NPU may obtain the first virtual box and the first class. For example, at least one of the GPU or the NPU, or any combination thereof may obtain a sub-class for acquiring a second class and the score of each of the plurality of points based on a second neural network model. For example, at least one of the GPU or the NPU may obtain a sub-class for acquiring a second class and the score of each of the plurality of points based on a second neural network model. For example, the CPU may classify second sub-points corresponding to a specified type among the plurality of points based on performing the first specified algorithm for classifying a type of each of the plurality of points.

As described above, the vehicle control device 100 according to an implementation may include at least one processor 110. The vehicle control device 100 may accurately detect the target object by detecting the target object using at least one processor 110. Additionally, the vehicle control device 100 may reduce the load on each processor by performing parallel processes.

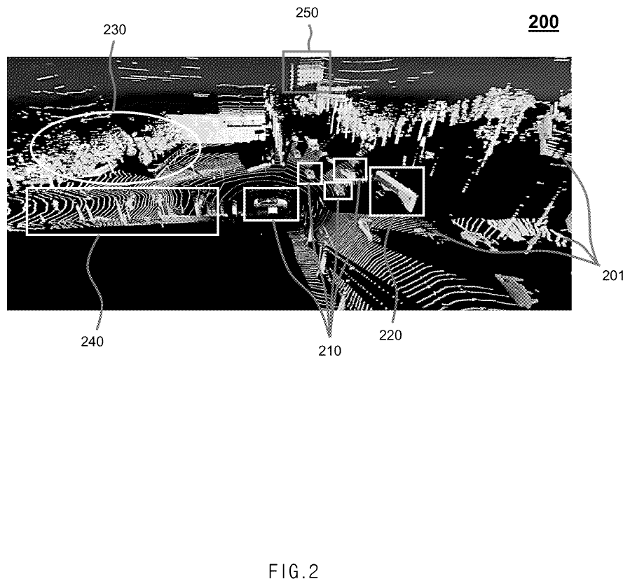

FIG. 2 is an illustrative diagram showing an example of a Bird's Eye View (BEV) of a LiDAR point cloud 200 to which KD-based GT filtering technology according to an implementation of the present disclosure is able to be applied.

The LiDAR 120 may emit laser beams into the surrounding environment, generate a point for each laser signal by recording the round-trip time it takes for the laser beam to reflect off an external object and return, and then calculate the distance to the point. By repeatedly emitting numerous laser beams, a real-time LiDAR map of the surrounding environment may be generated as shown in FIG. 2. The lines or surfaces shown in FIG. 2 can be composed of a large number of points 201. For this reason, LiDAR data as in FIG. 2 is also referred to as the point cloud 200. In some implementations, when combining an RGB-D (Red, Green, Blue-Depth) sensor with a LiDAR sensor, the point cloud 200 of FIG. 2 may be reconstructed in color.

In general, it can be difficult for humans to recognize objects from individual points 201 of a point cloud. However, when viewing a collection of points as the point cloud 200 as in FIG. 2, it becomes possible to visually estimate objects to some extent. For example, the object marked with reference number 210 may be inferred to be a car, and the object marked with reference number 220 may be inferred to be a bus. In AI recognition technology, a car or a bus may be referred to as an object, and may be classified into a class, such as a car class and a bus class, where a class represents a group of specific attributes of the object.

For reference, FIG. 2 illustrates a scene from a bird's eye view while flying over a city and therefore, in which case the scene may be called a BEV image.

In some implementations, in the LiDAR point cloud 200 of FIG. 2, various classes may be identified, including not only the class of vehicles but also the class of trees or forests 230, the class of roads 240, and the class of buildings 250, as examples.

In some scenarios, the LiDAR 120 is able to precisely measure a distance between objects 210 to 250 in the surrounding environment and a vehicle currently in motion (not shown), in which case the LiDAR 120 is able to provide detailed information for autonomous driving. In some implementations, a more accurate object recognition system for autonomous vehicles may be established through fusion with other sensors like RGB-D.

Machine learning techniques, such as those involving deep AI neural networks, can be implemented to distinguish the class of objects like cars 210 or buses 220 in the point cloud 200. In some implementations, the AI neural networks can include teacher networks (e.g., high-performed pre-trained networks) and student networks (e.g., networks that are trained to learn from the teacher networks). For example, in some scenarios, when an AI module is installed in a small sensor device, its performance may not compare to that of a large AI network (e.g., Teacher Network) operated by the processor 110 and the memory 130 installed in an autonomous vehicle or by an external autonomous driving support server. In such scenarios, the teacher network can be sufficiently trained in object recognition through machine learning, and a part of the learned content can be transferred from the teacher network to the student network. During this transfer process, in some implementations, some of the Teacher Network's extensive learned data can be intentionally reduced or deleted to provide a manageable amount of computational load for the Student Network. The process of transferring AI learning capability from the Teacher Network to the Student Network, with some potential loss of the AI learning capability can be implementing through Knowledge Distillation (KD).

To detect objects within the image of the LiDAR point cloud 200, as shown in FIG. 2, and identify their classes using an AI neural network, in some scenarios AI training may be performed beforehand. A dataset can be used to perform the training. For example, the PANDASET™ dataset (source: https;//pandaset.org/#data-collection) includes over 48,000 camera images (primarily of the Silicon Valley area in the United States) and over 16,000 LiDAR scan images. These images are annotated with a total of 28 classes, including pedestrians, cars, bicycles, construction site signs, traffic signs and the like.

In some implementations, the processor 110 according to implementations of the present disclosure or an external AI server (not shown) can serve as a teacher network. The teacher network can distinguish classes of object (such as pedestrians and cars) from numerous (e.g., tens of thousands) of images. In some scenarios, this can be applied in actual autonomous driving based on the LiDAR point cloud 200 data as shown in FIG. 2 transmitted by the LiDAR 120 to the processor 110 and the memory 130.

The example LiDAR point cloud 200 as shown in FIG. 2 can be visualized according to user preferences using point cloud tools like Open3D™ (source: https://www.open3d.org/). Because the LiDAR 120 is able to measure distances, the visualization tool, such as Open3D™, can render 3D LiDAR images more vividly by, for example, displaying distant objects in dark blue and closer objects in light blue.

Furthermore, in some implementations, pre-processing can be performed on the points cloud data. For example, pre-processing can be performed on an image by applying a technique called voxel down-sampling to the LiDAR point cloud 200 as shown in FIG. 2. Here, a voxel is a cube-shaped 3D unit element (analogous to a 2D pixel) that divides up the 3D point cloud space. Voxel down-sampling can use voxels to represent objects, to reduce the number of points 201 in the LiDAR point cloud 200 while maintaining the structures of the objects 210 to 250 included in the LiDAR point cloud 200.

For example, voxel down-sampling can reduce the total number of points 201 included in a LiDAR point cloud 200 by retaining only one point 201 per voxel (e.g., one point per one unit element cube that represents a voxel). In some implementations, voxels can be used as a technique to simplify a 3D structure and reduce data noise when implementing an object recognition algorithm. In some scenarios, the number of voxels can be adjusted by a user. For example, applying more voxels to the LiDAR point cloud 200 in FIG. 2 may remove more points 201 (e.g., as much as 1/7 of the original number of points).

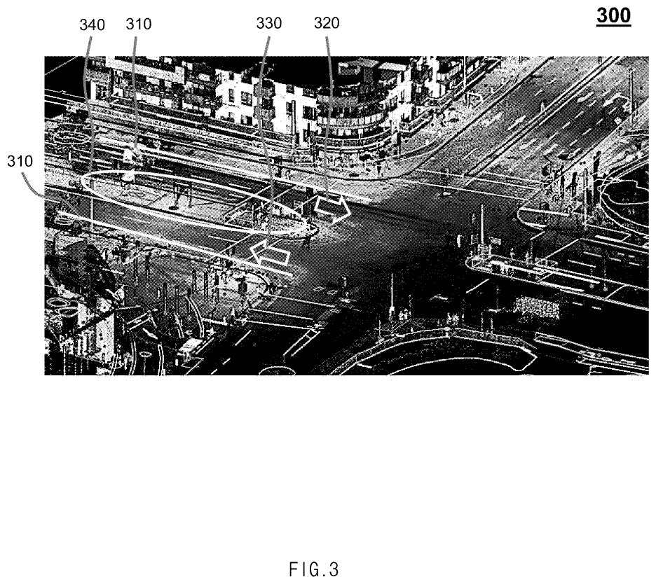

Next, FIG. 3 is a diagram showing an example intersection 300 to illustrate KD-based GT filtering technique according to an implementation of the present disclosure.

The LiDAR point cloud 200, along with the concepts of points, voxels, objects, classes, and the like, has been previously described with reference to FIG. 2. In FIG. 3, implementations of the present disclosure will be described with a focus on autonomous driving.

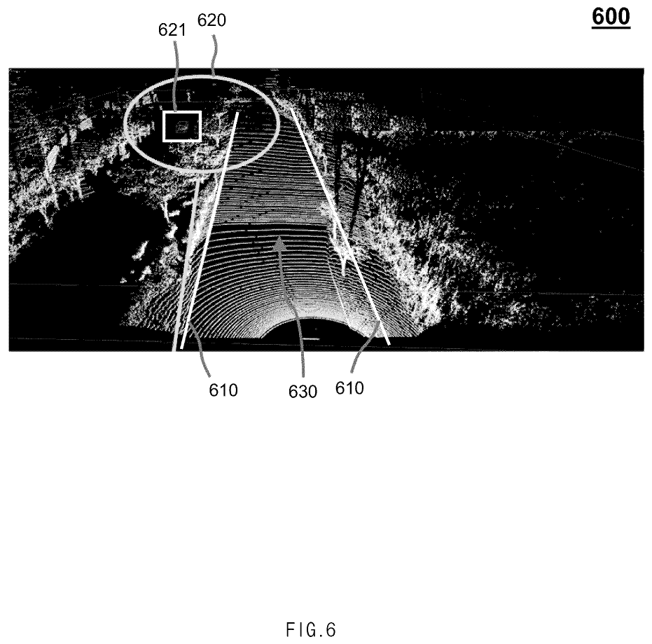

First, in the intersection 300 captured by the LiDAR as shown in the example of FIG. 3, the processor 110 (or reference number 1000 in FIG. 6) may execute a process to recognize a “drivable area” so as to process data related to autonomous driving. In some implementations, “ground/road” can be separated from obstacles such as vehicles, bicycles, pedestrians, or the like by processing the 3D point cloud. For example, when using the RANSAC (Random Sample Consensus) algorithm, outliers (e.g., objects exceeding a reference) and inliers (objects satisfying the reference) can be defined based on the reference. For instance, road contact points can be defined as inliers, while obstacles can be defined as outliers. In some implementations, a maximum distance can be set, and objects exceeding the maximum distance can also be defined as outliers.

Through such a process, for example, the processor 110 can identify road boundaries 310 on both sides of the intersection 300 in FIG. 3 and recognize the current driving direction 320 and the opposite lane's driving direction 330. In the example in FIG. 3, a lane separation area 340 for separating lane directions may also be observed.

In some implementations, segmentation processing can be performed further distinguish between different regions or areas of the data, and the different regions can be annotated for contrast. For example, the road area within the intersection 300 can be annotated in a red color, and the rest in a blue color. Additionally, using a clustering algorithm such as DBSCAN (Density-Based Spatial Clustering of Applications with Noise), clusters related to 3D objects can be generated based on the density of points 201, and utilizing 3D classification tools such as POINTNET™ (source: https://github.com/charlesq34/pointnet) can assist in AI learning and performance improvement according to the present disclosure. In some scenarios, e.g., when it is difficult to identify the direction of a driving lane, implementations of the present disclosure can analyze whether a specific object is in the same lane as the lane on which a vehicle is driving by using positioning information or segmentation information. The results of this analysis can be reflected in the GT label filtering process.

When AI preprocessing for the intersection 300 is completed as described above, in some implementations, a Ground Truth (GT) bounding box can be added. An example of the GT bounding box is shown on the objects in FIG. 2 for convenience of description (e.g., reference numerals 210, 220, and 250). For example, a 3D bounding box can be added to surround an object in a LiDAR image such as those in FIG. 2 or FIG. 3. In some implementations, various objects can be grouped together with labels. The interval of 3D data points used to output the GT bounding box can also need to be configured. As an example, one GT bounding box can be set to contain around 50 to 1000 points 201.

In machine learning, GT (Ground Truth) can represent the original or actual value of data that the AI machine learning algorithm is to learn. For example, GT can involve image annotation added to the LiDAR point cloud 200 as a bounding box with box-shaped boundaries, as shown in FIG. 2.

In some scenarios, the GT annotations do not exist in the raw data captured by sensors such as the LiDAR 120 during vehicle driving. In such scenarios, during object recognition the processor 110 can recognize objects such as road signs, crosswalks, pedestrians, other vehicles, and the center line as objects belonging to various classes. The GT annotations can be used to measure and evaluate object recognition errors by comparing the results of object recognition by the AI algorithm of the processor 110 with the actual objects. The GT bounding box, which can be added to the original image as annotations, can be set manually by a user, or can be generated by GT computation tools such as Grid-striding.

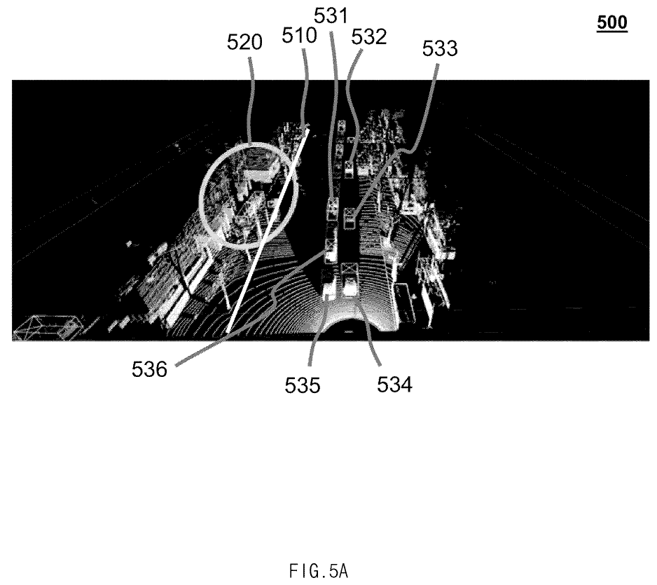

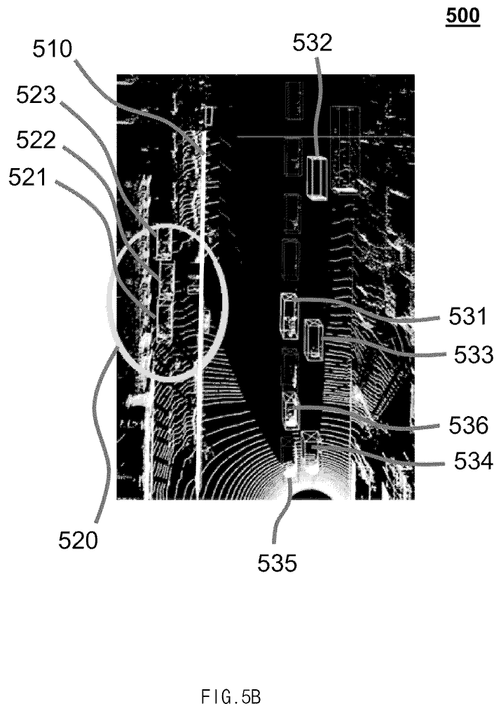

AI object recognition can also utilize predicted bounding boxes. For example, when an AI object recognition module is implemented, predicted bounding boxes can be observed (as shown in FIG. 5 and subsequent figures). The result recognized by the processor 110 as an object of a specific class (from the raw image data obtained from sensors such as the LiDAR 120) can appear in the form of a bounding box. In some scenarios, unlike GT bounding boxes, the predicted bounding boxes can be the result of the computation of the autonomous driving AI. The predicted bounding boxes may match the GT bounding boxes, or the predicted bounding boxes may not match or may not overlap the GT bounding boxes at all.

In some scenarios, predicted bounding boxes may not provide an exact location of an object, in which case it can be difficult to definitively conclude that an object of a specific class actually exists at a certain position based solely on predicted bounding boxes. As such, the predicted bounding boxes can also be referred to as P-Boxes (Probability Boxes).

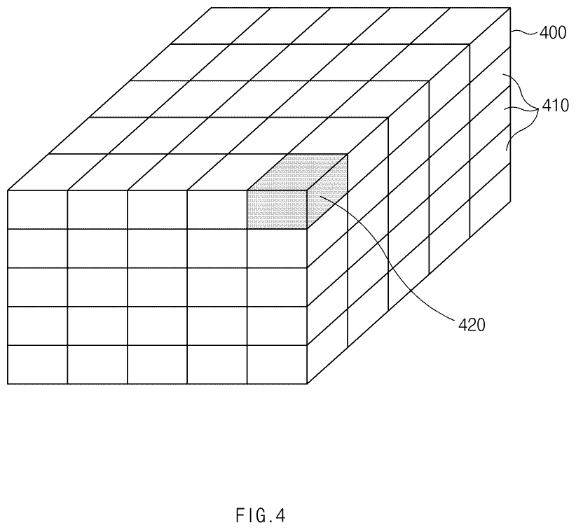

FIG. 4 is an illustrative diagram to describe an example of a method of calculating a voxel occupancy ratio according to an implementation of the present disclosure.

A voxel cube 400 illustrated in the example of FIG. 4 is composed of (5×5×5) voxels arranged along a width, height, and depth of the voxel cube 400. In this example, the voxel cube 400 contains 125 individual voxels 410. In some implementations, as discussed above, the total number of points in the LiDAR point cloud 200 can vary depending on how many voxels are applied during voxel down-sampling. For example, in some scenarios, (8×8×8) voxel cubes, i.e., cubes with 512 voxels each, can be used for GT filtering according to implementations of the present disclosure.

According to implementations of the present disclosure, the voxel cube 400 as shown in FIG. 4 or any other form of a voxel polyhedron can be applied to each object 210, 220, or the like in the LiDAR point cloud 200 of FIG. 2. For example, points constituting the car 210 in FIG. 2 may be likely to be included in multiple voxels of the voxel cube 400 (or voxel polyhedron), unless the car is remote or far away. When a point in the point cloud occupies a voxel, the voxel may be defined as an occupied voxel 420. The ratio of the number of occupied voxels to the total number of voxels constituting the voxel polyhedron, such as 125 voxels or 512 voxels, may be referred to as a voxel occupancy ratio in the present disclosure. However, because implementations of the present disclosure are applicable to two-dimensional data as well, the more generalized term “pixel occupancy ratio” can also be used to describe this concept, in scenarios where a voxel can be understood as a 3D pixel.

When the pixel occupancy ratio is calculated in the example of FIG. 4 with occupied voxel 420, the pixel occupancy ratio is 1/125, or 0.008. When the pixel occupancy ratio is converted to a percentage, the pixel occupancy ratio is 0.8%. Implementations of the present disclosure can implement GT filtering when the pixel occupancy ratio is lower than a certain reference or threshold. In some implementations, the criterion for determination of whether the pixel occupancy ratio is low or high may vary depending on a sensor model or a sensor's mounting position. For example, a high-resolution LiDAR sensor installed on the roof of a car may determine that an object with a pixel occupancy ratio of 15% or more is difficult to ignore in autonomous driving. When the same LiDAR sensor is mounted on an autonomous driving drone, an object will appear smaller than with a vehicle sensor, so that the criterion for the pixel occupancy ratio may drop to, for example, 10% or 5%. These are merely examples, and it should be noted that implementations of the present disclosure are not limited to LiDAR models, positions, or specific threshold values for pixel occupancy ratios.

FIGS. 5A and 5B are diagrams illustrating an example of a first case 500 to which the KD-based GT filtering technique according to an implementation of the present disclosure is applied.

Referring to FIG. 5A, a lane boundary 510 may be shown, and objects 520 may be shown for determination of whether to apply GT filtering. Additionally, at least six vehicles 531, 532, 533, 534, 535, and 536 and other objects presumed to be other vehicles, buildings, or the like are displayed in the first case 500.

As shown in FIG. 5B, when viewing the first case 500 from a different angle, it is seen that the objects 520 for the determination of whether to apply GT filtering include three buses 521, 522, and 523. When, for example, a voxel cube of size (8×8×8) is applied to each of the three buses 521, 522, and 523, the pixel occupancy ratios of the three buses 521, 522, and 523 would likely be high enough to make their exclusion from the GT objects difficult.

In this example, the three buses 521, 522, and 523 appear to be parked beyond the lane boundary 510 and may thus be objects that do not significantly impact autonomous driving. However, when the GT labeling for the three buses 521, 522, and 523 is excluded in the first case 500, the processor 110 may experience significant confusion in determining classes, as the three buses 521, 522, and 523 excluded from the GT labeling are highly similar in shape to other large vehicles 531, 532, and 533. As such, for the purpose of reducing the computational load for object recognition, it might seem unnecessary to perform object recognition operations on the three buses 521, 522, and 523 beyond the lane boundary 510. However, the GT filtering algorithm according to implementations of the present disclosure does not exclude the three buses 521, 522, and 523 from GT labeling in the first case 500, if it is recognized that these three buses 521, 522, and 523 are likely to have high pixel occupancy ratios, such that excluding these three buses 521, 522, and 523 from GT labeling could cause issues in generating P-Boxes for other similar objects.

FIG. 6 is a diagram for describing an example of a second case 600 to which the KD-based GT filtering technique according to an implementation of the present disclosure is applied.

In the second case 600, lane boundaries 610 on both sides are clearly identifiable. Therefore, a bounding box 621 within an area 620 intended for determination of whether apply GT filtering may reasonably be considered to have no significant impact on autonomous driving. Additionally, compared to the buses 521, 522, and 523 in the first case 500, the object 621 in the second case 600 would likely show a very low pixel occupancy ratio when a voxel cube of size (8×8×8) is applied. The object 621 is likely a car parked outside the lane. Unlike the buses 521, 522, and 523 in the first case 500, the object 621 in the second case 600 can be filtered from GT labeling because (i) the object 621 is an object outside the lane 610, and (ii) the object 621 has a low pixel occupancy ratio.

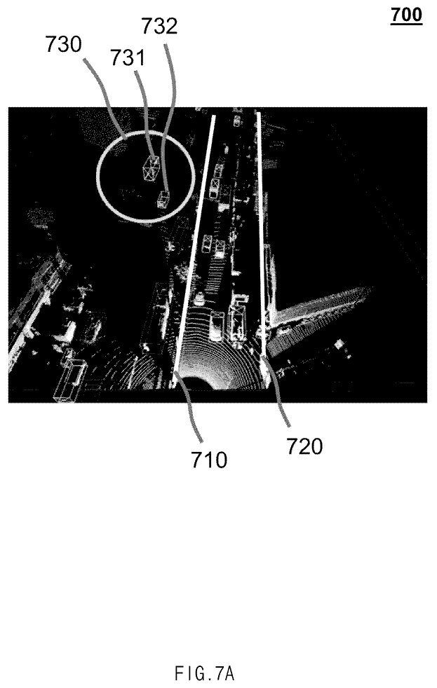

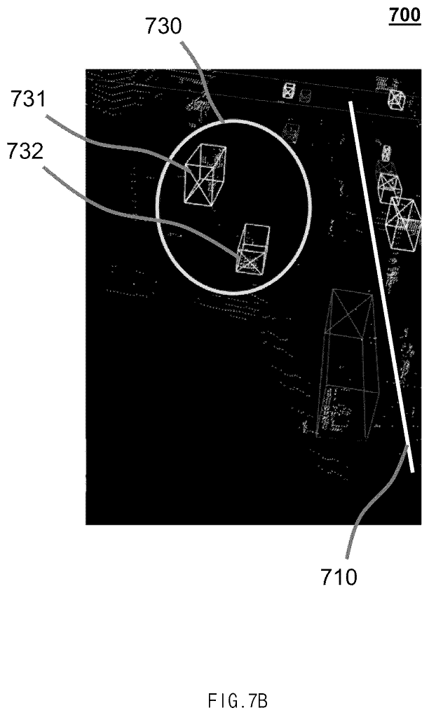

FIGS. 7A and 7B are diagrams for describing an example of a third case 700 to which the KD-based GT filtering technique according to an implementation of the present disclosure is applied.

Similar to FIG. 6, a left line 710 and a right line 720 are clearly identifiable in FIG. 7A, and an area 730 intended for determination of whether to apply the KD-based GT filtering is marked for convenience of description.

Referring to FIG. 7B, which enlarges a portion of FIG. 7A, two vehicles 731 and 732 may be seen in the area 730 intended for determination of whether to apply GT filtering. Although the third case 700 may appear similar to the first case 500, the two vehicles 731 and 732 would likely show relatively low pixel occupancy ratios when a voxel cube of size (8×8×8) is applied to the two vehicles 731 and 732. This is because, unlike the first case 500, the two vehicles 731 and 732 are positioned too far outside the road boundary 710, and it is almost certain from FIG. 7B that no vehicle currently driving on the road would suddenly drive toward objects 731 and 732.

Therefore, the vehicles 731 and 732 in the third case 700 will be filtered from GT labeling due to the following reasons: (i) the vehicles 731 and 732 are objects outside the line 710, (ii) pixel occupancy ratios of the objects 731 and 732 are low, and (iii) the objects 731 and 732 do not exist in a drivable area. The techniques for identifying drivable areas and driving directions can be implemented, for example, using implementations as described with reference to FIG. 3.

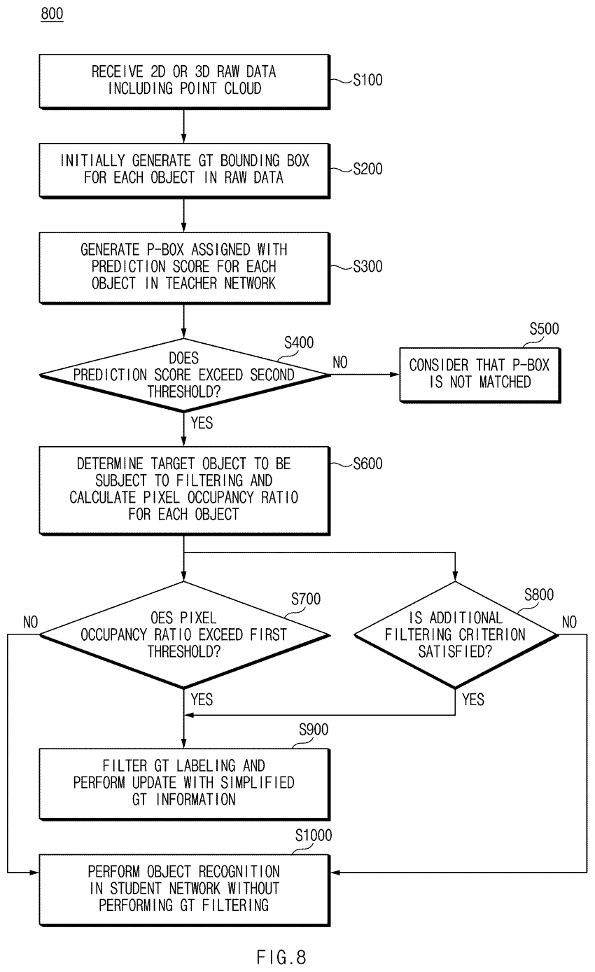

FIG. 8 is a flowchart generally illustrating an example of a KD-based GT filtering algorithm 800 according to an implementation of the present disclosure.

Referring to FIG. 8, in S100, the KD-based GT filtering algorithm according to implementations of the present disclosure, which can be included in the processor 110, may receive 2D or 3D raw data that includes a point cloud (as was shown in FIG. 2).

In S200, a GT bounding box can be initially generated for each object present in the raw data. The expression ‘initially generated’ here takes into account the possibility that some of the generated GT bounding boxes can be later removed in the subsequent S900.

In S300, a pre-trained network, such as a teacher network, can assign a prediction score to each object to create a P-Box using the KD technique described above. The prediction score can indicate how confident the AI is in generating the P-Box. Various techniques can be used to calculate the prediction score.

In S400, when the prediction score falls below a second threshold, it can be determined that a corresponding P-Box does not match (e.g., does not overlap) a GT bounding box (S500).

When the prediction score exceeds the second threshold in S400, then in S600, objects to be subject to GT filtering are selected and determined. For each object, a pixel occupancy ratio can be calculated using techniques described with reference to FIG. 4. In some implementations, calculation of the pixel occupancy ratio can also be performed for 2D pixels and is not limited to 3D pixels.

S700 and S800 can be executed sequentially, in parallel, or conditionally. In FIG. 8, S700 and S800 are executed in parallel as an example. However, this is merely an example, and those skilled in the art could change the execution order, priority, or omit part of operations according to the teachings of the present disclosure.

In S700, whether the pixel occupancy ratio exceeds a first threshold is determined, and in S800, AI determination can be performed based on additional filtering criteria. The additional filtering criteria can include, but are not limited to, lane direction, segmentation information, whether an object is in the same lane, whether an object is in an area where the host vehicle is currently able to drive, whether an object belongs to classes such as natural terrain or buildings, whether there exists another object similar to the one intended for removal (e.g., whether the filtering of a corresponding object could potentially cause confusion in AI determination for other objects), whether a BEV mode is entered, a sensor model, a sensor's mounting position, and others.

In some scenarios, some or all of the criteria applied in S800 may be closely related to the determination of the pixel occupancy ratio in S700, in which case it should be emphasized once again that the parallel execution of S700 and S800 in FIG. 8 is merely an example.

When an object is determined to be a filtering target in S700 or S800, information regarding the GT bounding box that was initially generated in S200 can be updated in S900. For example, GT bounding boxes of some objects can be considered unnecessary for autonomous driving and are then removed. This can help improve the efficiency of AI computation related to object recognition.

When, in S700 and S800, an object is not determined to be a filtering target, the object is treated as not being subject to GT filtering. In such scenarios, a learning network, such as the student network, may perform object recognition operations based on the simplified GT labeling through S100 to S900.

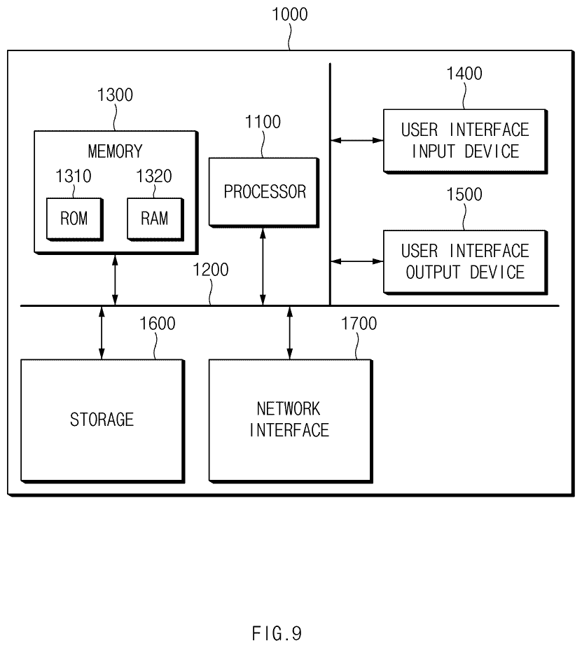

FIG. 9 is a block diagram illustrating an example of a computing system 1000 for autonomous vehicle control and object computation efficiency according to an implementation of the present disclosure.

Referring to FIG. 9, the computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a Read Only Memory (ROM) and a Random Access Memory (RAM).

Thus, the operations of the method or the algorithm described in connection with the implementations disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM.

The exemplary storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of the present disclosure, and various modifications and variations may be made without departing from the essential characteristics of the present disclosure by those skilled in the art to which the present disclosure pertains.

Accordingly, the implementation disclosed in the present disclosure is not intended to limit the technical idea of the present disclosure but to describe the present disclosure, and the scope of the technical idea of the present disclosure is not limited by the implementation. The scope of protection of the present disclosure should be interpreted by the following claims, and all technical ideas within the scope equivalent thereto should be construed as being included in the scope of the present disclosure.

Hereinabove, although the present disclosure has been described with reference to exemplary implementations and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A system configured to perform labeling of Ground Truth (GT) bounding boxes, the system comprising:
at least one processor; and
at least one memory storing computer program instructions that, based on being executed by the at least one processor, implement a first machine-learning network to perform artificial intelligence (AI)-based operations of recognizing objects in a surrounding environment for autonomous driving, the operations comprising:
obtaining point cloud data including a plurality of points, from a two-dimensional or three-dimensional image sensor used in the autonomous driving;
assigning, to the point cloud data, GT label data for a plurality of GT bounding boxes;
obtaining, from a second machine-learning network that has been pre-trained, Probability Box (P-Box) label data for a plurality of predicted bounding boxes based on the point cloud data;
selecting an object that overlaps the P-Box label data from the GT label data;
determining, in the point cloud data, a geometric region that corresponds to the object;
determining an occupancy ratio that relates to an extent to which the selected object occupies the corresponding geometric region;
based on a determination that the determined occupancy ratio for the object does not satisfy a first criteria, filtering out the GT label data assigned to the object that does not satisfy the first criteria; and
updating the GT label data based on filtering out the GT label data assigned to the object that does not satisfy the first criteria.

2. The system of claim 1, wherein, among the plurality of predicted bounding boxes obtained from the second machine-learning network, a predicted bounding box whose prediction score satisfies a second criteria is included in the P-Box label data.

3. The system of claim 1, wherein the image sensor comprises a LiDAR, and
wherein the geometric region that corresponds to the object comprises a polyhedron of voxels, and the occupancy ratio comprises a voxel occupancy ratio of the object in the polyhedron of voxels.

4. The system of claim 1, wherein, in addition to the first criteria, an additional filtering criterion is used for filtering the GT label data, wherein the additional filtering criterion depends on at least one driving situation during the autonomous driving.

5. The system of claim 4, wherein the additional filtering criterion that depends on the at least one driving situation comprises determining a class to which the object belongs.

6. The system of claim 4, wherein the additional filtering criterion comprises determining whether the object is located outside of a road boundary.

7. The system of claim 4, wherein the additional filtering criterion comprises determining whether the object is located in an area where a vehicle currently in use is unable to physically drive.

8. The system of claim 4, wherein the additional filtering criterion comprises determining whether the object is located along a driving direction of a vehicle currently in use,
wherein the driving direction is determined by using at least one of positioning information or segmentation information.

9. The system of claim 3, wherein determining the occupancy ratio for the selected object in the corresponding geometric region comprises:
determining the geometric region as a size (a×b×c) polyhedron of voxels,
identifying a voxel, among the voxels in the polyhedron, that is occupied by at least one of the plurality of points as an occupied voxel, and
determining the occupancy ratio by determining a number of occupied voxels compared to a total number of voxels in the size (a×b×c) polyhedron of voxels.

10. The system of claim 9, wherein the first criteria comprise a threshold for the occupancy ratio, and
wherein the threshold is variable depending on a type of the LiDAR or a mounting position of the LiDAR.

11. A method of labeling Ground Truth (GT) bounding boxes in artificial-intelligence (AI)-based object recognition implemented by a first machine-learning network for autonomous driving, the method comprising:
obtaining point cloud data including a plurality of points, from a two-dimensional or three-dimensional image sensor used in the autonomous driving;
assigning, to the point cloud data, GT label data for a plurality of GT bounding boxes;
obtaining, from a second machine-learning network that has been pre-trained, Probability-Box (P-Box) label data for a plurality of predicted bounding boxes based on the point cloud data;
selecting an object that overlaps the P-Box label data from the GT label data;
determining, in the point cloud data, a geometric region that corresponds to the object;
determining an occupancy ratio that relates to an extent to which the selected object occupies the corresponding geometric region;
based on a determination that the determined occupancy ratio for the object does not satisfy a first criteria, filtering out the GT label data assigned to the object that does not satisfy the first criteria; and
updating the GT label data based on filtering out the GT label data assigned to the object that does not satisfy the first criteria.

12. The method of claim 11, wherein, among the plurality of predicted bounding boxes obtained from the second machine-learning network, a predicted bounding box whose prediction score satisfies a second criteria is included in the P-Box label data.

13. The method of claim 11, wherein the image sensor comprises a LiDAR, and
wherein the geometric region that corresponds to the object comprises a polyhedron of voxels, and the occupancy ratio comprises a voxel occupancy ratio of the object in the polyhedron of voxels.

14. The method of claim 11, wherein in addition to the first criteria, an additional filtering criterion is used for filtering the GT label data, wherein the additional filtering criterion depends on at least one driving situation during the autonomous driving.

15. The method of claim 14, wherein the additional filtering criterion that depends on the at least one driving situation comprises determining a class to which the object belongs.

16. The method of claim 14, wherein the additional filtering criterion comprises determining whether the object is located outside of a road boundary.

17. The method of claim 14, wherein the additional filtering criterion comprises determining whether the object is located in an area where a vehicle currently in use is unable to physically drive.

18. The method of claim 14, wherein the additional filtering criterion comprises determining whether the object is located along a driving direction of a vehicle currently in use,
wherein the driving direction is determined by using at least one of positioning information or segmentation information.

19. The method of claim 13, wherein determining the occupancy ratio for the selected object in the corresponding geometric region comprises:
determining the geometric region as a size (a×b×c) polyhedron of voxels,
identifying a voxel, among the voxels in the polyhedron, that is occupied by at least one of the plurality of points as an occupied voxel, and
determining the occupancy ratio by determining a number of occupied voxels compared to a total number of voxels in the size (a×b×c) polyhedron of voxels.

20. The method of claim 19, wherein the first criteria comprise a threshold for the occupancy ratio, and
wherein the threshold is variable depending on a type of the LiDAR or a mounting position of the LiDAR.
